(19) United States
(12) Patent Application Publication
(10) Pub. No.: US 2004/0246350 A1
(43) Pub. Date: Dec. 9, 2004

(54) Image pickup apparatus capable of reducing noise in image signal and method for reducing noise in image signal

(75) Inventor: Shohei Sakamoto, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co. , Ltd., Tokyo (JP)

(21) Appl. No.: 10/860,406

(22) Filed: Jun. 2, 2004

(30) Foreign Application Priority Data
Jun. 4, 2003 (JP) 2003-158929

(51) Int. Cl. H04N 5/217

(52) U.S. Cl. 348/241

(57) ABSTRACT

Noise included in image data output from an analog processing unit, is eliminated by a noise reduction circuit. The noise reduction circuit restricts a difference between a value of each of peripheral pixels and a value of a center pixel to a value a value having a predetermined noise constant defined as an upper limit with respect to each of the peripheral pixels, e.g., a pixel space of 5×5. The values of the peripheral pixels whose upper limits are restricted are defined as new values of the peripheral pixels. The value of the center pixel is converted into a value obtained by averaging the new values of the peripheral pixels and the value of the center pixel. In this manner, low pass filter processing is carried out.

### CROSS-REFERENCE TO RELATED APPLICATIONS

This application is based upon and claims the benefit of priority from prior Japanese Patent Application No. 2003-158929, filed Jun. 4, 2003, the entire contents of which are incorporated herein by reference.

### BACKGROUND OF THE INVENTION

1. Field of the Invention

The present invention relates to an image pickup apparatus capable of being applied to a digital camera or the like and a method for reducing an image signal noise in the image pickup apparatus.

2. Description of the Related Art

Conventionally, in an image pickup apparatus such as a digital camera, for example, a method using a smoothing filter or a median cut filter is known as a method for reducing a noise from an image signal output from an image pickup device and converted into a digital signal.

However, in the case where these filters are applied to the image signal, an edge component of an image as well as a noise component of an image is lost. Therefore, it is required to eliminate or reduce a noise component without degrading an edge component.

### BRIEF SUMMARY OF THE INVENTION

The present invention is directed to method and apparatus that substantially obviates one or more of the problems due to limitations and disadvantages of the related art.

According to an embodiment of the present invention, an image pickup apparatus comprises an image sensor which picks up an object and outputs an image signal, a low pass filter processing unit which executes low pass filter processing in which a value obtained by averaging a value of a target pixel of interest and values of peripheral pixels in the periphery of the target pixel of interest is defined as a new value of the target pixel of interest, with respect to the image signal output from the image sensor, and a memory which stores the image signal to which low pass filter processing has been applied by the low pass filter processing unit, wherein the low pass filter processing unit comprises a restriction unit which restricts the values of the peripheral pixels to a predetermined range around the value of the target pixel of interest when the low pass filter processing is executed for the image signal.

According to another embodiment of the present invention, an image pickup apparatus comprises means for picking up an object to output an image signal, low pass filter processing means for executing low pass filter processing in which a value obtained by averaging a value of a target pixel of interest and values of peripheral pixels in the periphery of the target pixel of interest is defined as a new value of the target pixel of interest, with respect to the image signal output from the picking up means; and means for storing the image signal to which low pass filter processing has been applied by the low pass filter processing means, wherein the low pass filter processing means comprises means for restricting the values of the peripheral pixels to a predetermined range around the value of the target pixel of interest when the low pass filter processing is executed for the image signal.

According to still another embodiment of the present invention, a noise canceling method comprises picking up an object to output an image signal comprising pixels, restricting a value of each of peripheral pixels so that a difference between a value of a target pixel of interest and the value of each of the peripheral pixels is not larger than a value having a predetermined noise constant, and converting a value of a target pixel of interest into a value obtained by averaging a new value of each of the peripheral pixels and a value of the target pixel of interest.

According to further embodiment of the present invention, a computer program for an image pickup apparatus, the program being stored in a computer readable medium, and the program comprises picking up an object to output an image signal comprising pixels, restricting a value of each of peripheral pixels so that a difference between a value of a target pixel of interest and the value of each of the peripheral pixels is not larger than a value having a predetermined noise constant, and converting a value of a target pixel of interest into a value obtained by averaging a new value of each of the peripheral pixels and a value of the target pixel of interest.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram of a digital camera showing one embodiment of the present invention;

FIG. 2 is a block diagram showing a signal processing unit shown in FIG. 1 in detail;

FIG. 3 is a flow chart showing a processing algorithm in a noise reduction circuit shown in FIG. 2;

FIG. 4A is a view showing a pixel space which serves as a processing unit of a noise reduction processing; and

FIGS. 4B, 4C, and 4D are views each showing a target pixel of interest and a peripheral pixel in the pixel space.

### DETAILED DESCRIPTION OF THE INVENTION

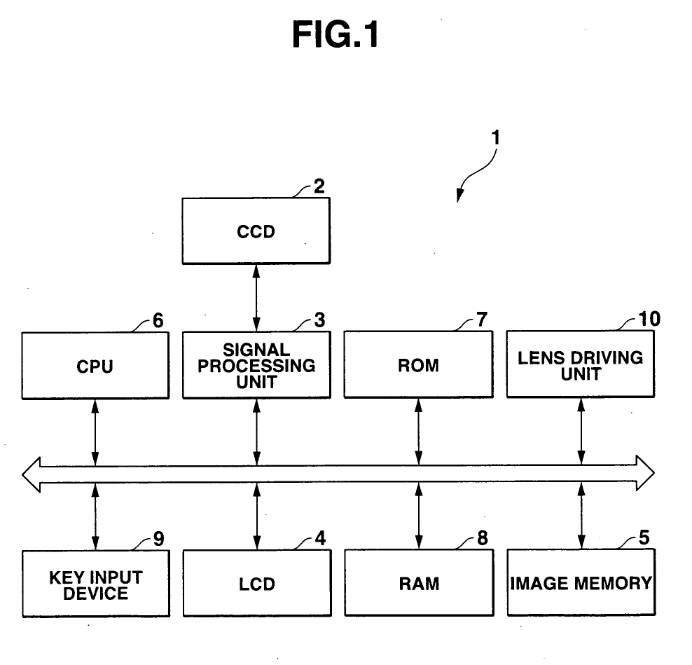

An embodiment of the present invention will now be described with reference to the accompanying drawings. FIG. 1 is a block diagram illustrating a general configuration of a digital camera 1 according to the present embodiment.

The digital camera 1 is configured to pick up an object as an image by means of a CCD (Charge Coupled Device) 2 which is an example of an image pickup device, display the object image acquired by the CCD 2 on an LCD (Liquid Crystal Display) 4, and convert the picked up object image into image data, thereby recording the image data in an image memory 5. The image memory 5 comprises a nonvolatile memory such as a flash memory which can be incorporated in a camera main body or which is removable.

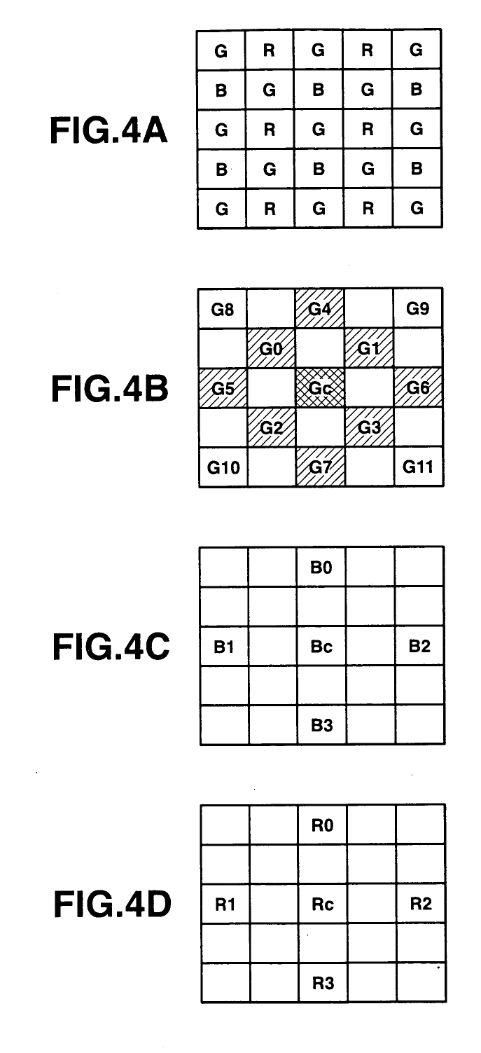

In the CCD 2, a primary color filter of a Beyer array (refer to FIG. 4A) is provided at a photosensitive portion. An analog image pickup signal output from the CCD 2 is subjected to a variety of signal processing operations by a signal processing unit 3. Finally, YUV data containing a brightness signal (Y signal) and a color difference signal (Cb signal and Cr signal), i.e., a digital image signal is output.

The image signal output from the signal processing unit 3 is fed to the LCD 4 while in a photography waiting state, and is displayed as an object image. During a photographing operation, the object image is compressed in accordance with a predetermined format such as JPEG by a CPU 6, and the compressed object image is recorded in the image memory 5. The image data after compressed, the image data being recorded in the image memory 5, is read out by the CPU 6 as required, and the read out image data is decompressed. Then, the decompressed image data is reproduced and displayed as a still picture or a motion picture in the LCD 4.

The digital camera 1 further comprises a ROM 7 having stored therein a variety of control programs required for compression and decompression of the above-described image data and control of the whole apparatus, a RAM 8 which is a work memory of the CPU 6, a key input device 9, and a lens driving unit 10. The key input device 9 comprises a shutter key and a mode change key used for changing an operating mode, and the like, and outputs an operating signal according to key operation to the CPU 6. The lens driving unit 10 comprises a motor for driving in an optical axis direction a lens group which includes a focus lens disposed on a front face of the CCD 2, a driver for controlling the motor, and the like. The lens position is changed based on a command from the CPU 6 while in AF control.

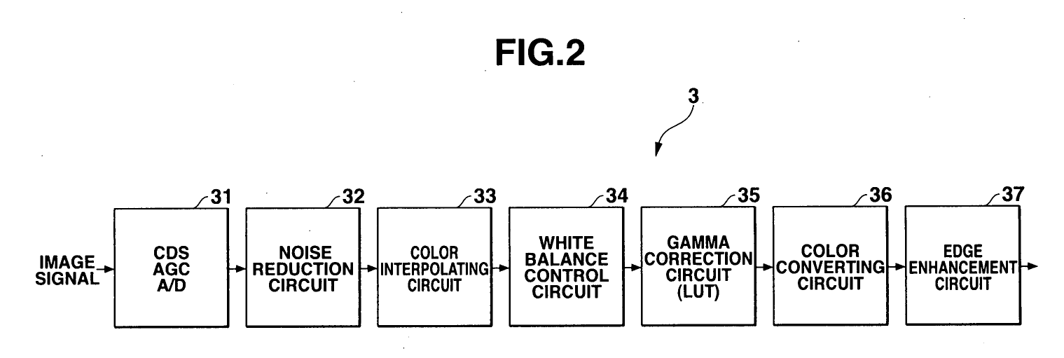

FIG. 2 is a block diagram illustrating the previously described signal processing unit 3 in detail. The signal processing unit 3 comprises an analog processing unit 31 for inputting an analog image pickup signal output from the CCD 2, a noise reduction circuit 32, a color interpolating circuit 33, a white balance control circuit 34, a gamma correcting circuit (gamma LUT) 35, a color converting circuit 36, and an edge enhancement circuit 37.

The analog processing unit 31 includes a correlation double sampling circuit (a CDS circuit) for reducing a drive noise of the CCD 2 included in an image pickup signal output from the CCD 2, an auto gain control circuit (an AGC circuit) for controlling a gain of the signal after noise reduction, and an A/D converter for converting a signal after gain controlled to a digital signal. This analog processing unit 31 converts an analog image pickup signal output from the CCD 2 into a digital image signal (Beyer data). The noise reduction circuit 32 reduces a noise mixed in the image pickup signal output from the analog processing unit 31. This noise reduction circuit 32 will be described later in detail.

The color interpolating circuit 33 generates RGB data for all pixels by carrying out color interpolation for each of the color components R, G, and B from the Beyer data from which the above-described noise has been reduced. The white balance control circuit 34 controls a white balance by carrying out gain control for each of the color components R, G, and B based on color information on all the pixels of an image. The gamma correcting circuit 35 carries out correction of gamma characteristics (gradation characteristics) with respect to an image signal.

The color converting circuit 36 generates YUV data which contains a brightness signal (Y signal) and a color difference signal (Cb signal and Cr signal) from the color component data for R, G, and B. The edge enhancement circuit 37 controls an amplitude of the Y signal in the YUV data by means of a high pass filter or a mask filter, thereby carrying out edge enhancement. In addition, this edge enhancement circuit eliminates the noise produced by edge enhancement by coring processing or the like, and outputs the image signal after processed to the CPU 6 or LCD 4.

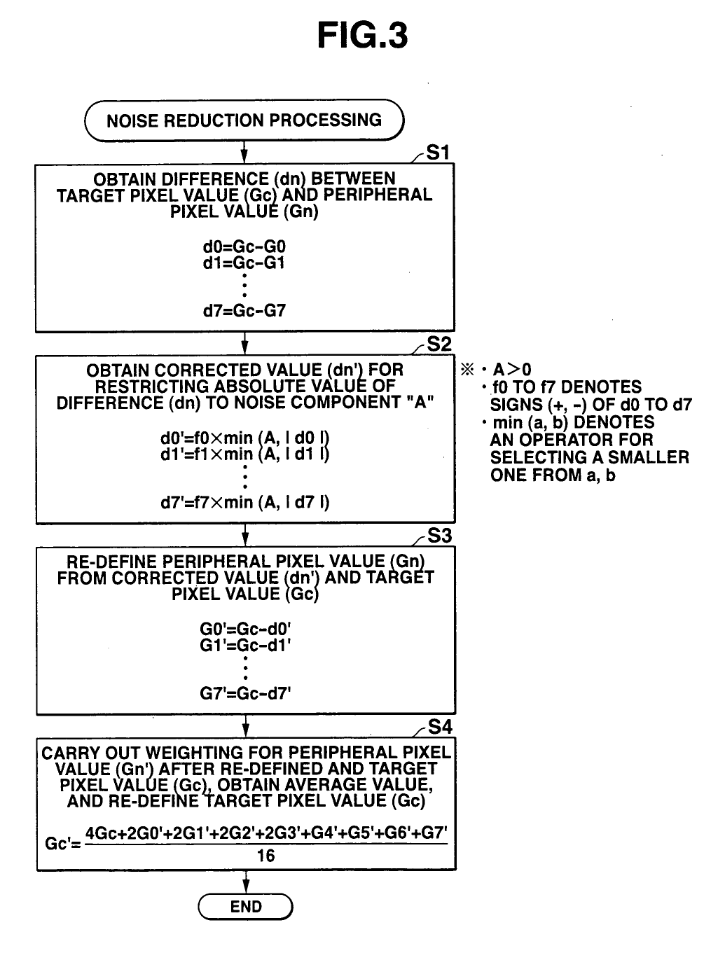

Now, the above-described noise reduction circuit 32 will be described in detail. The noise reduction circuit 32 is a so-called low pass filter. This noise reduction circuit 32 comprises a line memory for 5 lines; a delay device for 5 pixels; and a subtractor, an absolute value calculator circuit, and a limiter or the like each are connected to an output of the delay device, although not shown. Noise reduction processing is carried out in accordance with the processing algorithm shown in FIG. 3, thereby reducing a noise in the Beyer data output from the analog processing unit 31.

That is, the noise reduction circuit 32 carries out the following operation for RGB color component data while a 5×5 pixel space shown in FIG. 4A is defined as a processing unit. First, a description of G data will be given here. As shown in FIG. 4B, referring to a pixel value of a target pixel of interest (a center pixel) and pixel values of its peripheral 8 pixels, differences d0 to d7 between the pixel value Gc of the target pixel and pixel values G0 to G7 are calculated (step S1). The absolute values of the differences d0 to d7 are restricted to a predetermined noise constant “A” (A>0), and the results are defined as corrected values d0′ to d7′ (step S2). A value obtained by subtracting each of the thus obtained corrected values d0′ to d7′ from the target pixel value Gc of interest is redefined as the peripheral pixel values G0′ to G7′ (step S3). Namely, in steps S1 to S3, each of the peripheral pixel values G0 to G7 is limited to a value of a predetermined range [Gc−A, Gc+A]. Then, the redefined peripheral pixel values G0′ to G7′ and the target pixel value Gc of interest are weighted; an average value is obtained; and an average value filter (a linear smoothing filter) computation is carried out while the result is redefined as a value Gc′ of the target pixel of interest (step S4). That is, the target pixel value G0 of interest is converted into a value G0′ close to an original value which is not affected by the peripheral pixel values G0 to G7 up to a predetermined amount or more, thereby carrying out noise reduction. A weighting multiple (×4, ×2, ×1) as shown in FIG. 3 with respect to the target pixel value Gc of interest and the peripheral pixel values G0′ to G7′ after redefined is provided as a mere example.

Continuously, processing similar to that for the above-described G data is carried out for B and R color component data as well, and noise is reduced. At this time, as shown in FIGS. 4C and 4D, processing may be carried out for the target pixel values Bc, Rc of interest by using the peripheral pixel values B0 to B3, R0 to R3 instead of those for 9 pixels. In addition, with respect to the above-described weighting multiple, for example, the target pixel value of interest may be defined as ×2, and the peripheral pixel value may be defined as ×1.

As has been described above, during processing in the above-described noise reduction circuit 32, the target pixel value of interest is converted into a value close to an original value which is not affected by the peripheral pixel value up to a predetermined amount or more, for RGB color component data for the Beyer data output from the analog processing unit 31. Thus, the low amplitude noise mixed in an image pickup signal can be reduced while a large amplitude component such as an edge is maintained. In addition, with respect to a pixel of an edge portion as well, averaging is carried out with the peripheral pixel value (a corrected value) close to the target pixel value of interest, and thus, a noise on an edge can also be reduced without degrading the edge. Moreover, the same processing is merely applied to an image signal regardless of the target pixel value of interest or the peripheral pixel value. Therefore, a signal processing system is simplified, noise reduction can be carried out at a low cost, and an image quality with less degradation can be acquired.

In the present embodiment, although noise reduction processing (low pass filter processing) has been carried out while all of the RGB color component data are defined as a processing target, noise reduction processing may be applied for only G data whose brightness component is the largest in quantity. In that case as well, a practical advantageous effect can be achieved.

Furthermore, when G data is defined as a target, although average value filter computation has been carried out by using the target pixel value Gc of interest and the values G0′ to G7′ after redefined, of the peripheral 8 pixels, the number of peripheral pixels to be used may be increased to 12 pixels. Namely, after the peripheral pixel values G0 to G11 shown in FIG. 4B are restricted to values of a predetermined range [Gc−A, Gc+A], average value filter computation may be carried out by using them.

The value of the previously described noise constant “A” is arbitrary. The noise elimination capability can be enhanced by increasing this value. However, if it is excessively large, an edge component is degraded. On the contrary, if the value is reduced, the edge component can be left. However, if it is excessively small, noise cannot be eliminated. Therefore, design may be properly made according to tradeoff between these.

Moreover, in the present embodiment, weighting has been carried out for each pixel value in the average value filter computation of step S4. Thus, the target pixel value of interest can be converted into a value close to an original value which is not affected by the peripheral pixel values up to a predetermined amount or more, and the degree of effect can be controlled from the peripheral pixel values reflected on the target pixel value of interest after converted. Therefore, the degree of freedom on design of a noise reduction processing system is wide, and its design is facilitated. Such weighting is not indispensable, and may be eliminated.

On the other hand, while the present embodiment has described a case in which noise reduction processing using the previously described algorithm is carried out for the Beyer data output from the analog processing unit 31, the above-described noise reduction processing can be carried out for brightness (Y) data for the YUV data generated at the color converting circuit 36, for example. In this case as well, noise of a low amplitude can be eliminated while a large amplitude component such as an edge is maintained. In addition, a noise on an edge can be reduced while an edge quality is maintained.

In this regard, in the present embodiment, a hardware resource can be reduced by carrying out the above-described noise reduction processing for an image signal obtained at a stage of Beyer data, namely, for that obtained earlier than color separation. That is, if Beyer data is defined as a processing target, subtraction processing is carried out for 8 pixels obtained by adding a target pixel of interest and the peripheral pixels, whereby compatibility with a 5×5 pixel space can be obtained. However, in the case where brightness data is defined as a processing target, subtraction processing or the like for 25 pixels (5×5) is required to cope with a similar pixel space, thus requiring the corresponding configuration.

The present embodiment has described a case in which the CCD 2 comprises a Beyer-array primary color filter, and an image signal earlier than color separation is Beyer data. However, also if the CCD 2 (which may be a MOS type image pickup device) is configured to have another color array filter, the above-described advantageous effect can be attained by carrying out noise reduction processing similar to that of the present embodiment for an image signal earlier than color separation.

Further, in the present embodiment, uniform noise reduction can be carried out from a low gradation region to a high gradation region because noise reduction processing is carried out before gamma conversion. If noise reduction is carried out after gamma conversion, there is a need for varying noise constant “A” depending on gradation (because a noise in a low gradation region is amplified after gamma conversion has been carried out). However, if noise reduction is carried out before gamma conversion, as in the present embodiment, there is no need for such varying operation. Therefore, a hardware resource can be reduced by doing this.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present embodiment has described a case in which the present invention is primarily applied to a digital camera for mainly photographing and recording a still picture, the present invention can be carried out in another imaging equipment which requires processing of an image signal such as a digital video camera.

What is claimed is:

1. An image pickup apparatus comprising:
an image sensor which picks up an object and outputs an image signal;
a low pass filter processing unit which executes low pass filter processing in which a value obtained by averaging a value of a target pixel of interest and values of peripheral pixels in the periphery of the target pixel of interest is defined as a new value of the target pixel of interest, with respect to the image signal output from the image sensor; and
a memory which stores the image signal to which low pass filter processing has been applied by the low pass filter processing unit,
wherein the low pass filter processing unit comprises a restriction unit which restricts the values of the peripheral pixels to a predetermined range around the value of the target pixel of interest when the low pass filter processing is executed for the image signal.

2. An image pickup apparatus according to claim 1, wherein
the restriction processing unit restricts a difference between a value of the target pixel of interest and each of the peripheral pixels to a value having a predetermined noise constant defined as an upper limit, and
the low pass filter processing unit defines values of peripheral pixels whose upper limits are restricted by the restriction processing unit as new values of the peripheral pixels, and converts a value of a target pixel of interest into a value obtained by averaging a new value of each of the peripheral pixels and a value of the target pixel of interest.

3. An image pickup apparatus according to claim 1, wherein the low pass filter processing unit carries out predetermined weighting for a value of each pixel when carrying out averaging between a value of the target value of interest and values of peripheral pixels in the periphery of the target pixel of interest.

4. An image pickup apparatus according to claim 1, wherein the image sensor comprises an optical color filter of plural colors which are different from one another in spectroscopic characteristics, the filter being disposed on the image sensor, and the image sensor comprises a color interpolation processing unit which applies color interpolation processing to the image signal to which low pass filter processing has been applied by the low pass filter processing unit, and
the memory stores the image signal to which color interpolation processing has been applied by the color interpolation processing unit.

5. An image pickup apparatus according to claim 4, further comprising a color conversion processing unit which converts the image signal to which color interpolation processing has been applied by the color interpolation processing unit into a brightness signal and a color difference signal, and wherein the memory stores the brightness signal and the color difference signal converted by the color conversion processing unit.

6. An image pickup apparatus according to claim 4, wherein
the optical color filter comprises an optical color filter of red, green, and blue, and
the low pass filter processing unit defines a value obtained by averaging a value of a target green pixel of target and values of plural peripheral green pixels in the periphery of the target green pixel of interest as a new value of the target green pixel of interest, with respect to the image signal output from the image sensor.

7. An image pickup apparatus according to claim 6, wherein the low pass filter processing unit executes low pass filter processing with defining a value obtained by averaging a value of the target green pixel of interest and values of 8 peripheral green pixels in the periphery of the target green pixel of interest as a new value of the target green pixel of interest, with respect to the image signal output from the image sensor.

8. An image pickup apparatus according to claim 4, wherein
the optical color filter comprises an optical color filter of red, green, and blue, and
the low pass filter processing unit defines a value obtained by averaging a value of a target blue pixel of target and values of plural peripheral blue pixels in the periphery of the target blue pixel of interest as a new value of the target blue pixel of interest, with respect to the image signal output from the image sensor.

9. An image pickup apparatus according to claim 8, wherein the low pass filter processing unit executes low pass filter processing with defining a value obtained by averaging a value of the target blue pixel of interest and values of 8 peripheral blue pixels in the periphery of the target blue pixel of interest as a new value of the target blue pixel of interest, with respect to the image signal output from the image sensor.

10. An image pickup apparatus according to claim 4, wherein
the optical color filter comprises an optical color filter of red, green, and blue, and
the low pass filter processing unit defines a value obtained by averaging a value of a target red pixel of target and values of plural peripheral red pixels in the periphery of the target red pixel of interest as a new value of the target red pixel of interest, with respect to the image signal output from the image sensor.

11. An image pickup apparatus according to claim 10, wherein the low pass filter processing unit executes low pass filter processing with defining a value obtained by averaging a value of the target red pixel of interest and values of 8 peripheral red pixels in the periphery of the target red pixel of interest as a new value of the target red pixel of interest, with respect to the image signal output from the image sensor.

12. An image pickup apparatus according to claim 1, further comprising a gamma conversion processing unit which applies gamma conversion processing to the image signal to which low pass filter processing has been applied by the low pass filter processing unit, and
wherein the memory stores the image signal to which gamma conversion processing has been applied by the gamma conversion processing unit.

13. An image pickup apparatus according to claim 1, further comprising a white balance processing unit which applies white balance control to the image signal to which low pass filter processing has been applied by the low pass filter processing unit, and
wherein the memory stores the image signal for which white balance has been controlled by the white balance processing unit.

14. An image pickup apparatus according to claim 1, further comprising an edge enhancement processing unit which applies edge enhancement processing to the image signal to which low pass filter processing has been applied by the low pass filter processing unit, and
wherein the memory stores the image signal edge-enhanced by the edge enhancement processing unit.

15. An image pickup apparatus according to claim 1, further comprising a compression processing unit which compresses the image signal to which low pass filter processing has been applied by the low pass filter processing unit, and
wherein the memory stores the image signal compressed by the compression processing unit.

16. An image pickup apparatus according to claim 1, further comprising an analog-to-digital conversion processing unit which converts an analog image signal output from the image sensor into a digital image signal, and
wherein the low pass filter processing unit executes low pass filter processing for the digital image signal converted by the analog-to-digital conversion processing unit.

17. An image pickup apparatus according to claim 1, further comprising a display which displays the image signal to which low pass filter processing has been applied by the low pass filter processing unit.

18. An image pickup apparatus comprising:
means for picking up an object to output an image signal;
low pass filter processing means for executing low pass filter processing in which a value obtained by averaging a value of a target pixel of interest and values of peripheral pixels in the periphery of the target pixel of interest is defined as a new value of the target pixel of interest, with respect to the image signal output from the picking up means; and
means for storing the image signal to which low pass filter processing has been applied by the low pass filter processing means,
wherein the low pass filter processing means comprises means for restricting the values of the peripheral pixels to a predetermined range around the value of the target pixel of interest when the low pass filter processing is executed for the image signal.

19. A noise canceling method comprising:
picking up an object to output an image signal comprising pixels;
restricting a value of each of peripheral pixels so that a difference between a value of a target pixel of interest and the value of each of the peripheral pixels is not larger than a value having a predetermined noise constant;
defining values of peripheral pixels whose upper limits are restricted as new values of the peripheral pixels; and
converting a value of a target pixel of interest into a value obtained by averaging a new value of each of the peripheral pixels and a value of the target pixel of interest.

20. A computer program for an image pickup apparatus, the program being stored in a computer readable medium, and the program comprising:
picking up an object to output an image signal comprising pixels;
restricting a value of each of peripheral pixels so that a difference between a value of a target pixel of interest and the value of each of the peripheral pixels is not larger than a value having a predetermined noise constant;
defining values of peripheral pixels whose upper limits are restricted as new values of the peripheral pixels; and
converting a value of a target pixel of interest into a value obtained by averaging a new value of each of the peripheral pixels and a value of the target pixel of interest.
